(19) United States
(12) Patent Application Publication
(10) Pub. No.: US 2024/0217411 A1
(43) Pub. Date: Jul. 4, 2024

(54) MODULAR SQUAB CUSHION COMPRISING A MODULAR LATERAL BOLSTER, AND SEAT ASSEMBLY COMPRISING SUCH A CUSHION AND SUCH A BOLSTER

(71) Applicant: FAURECIA Sièges d'Automobile, NANTERRE (FR)

(72) Inventors: Carsten REITH, NIEDERNWÖHREN (DE); Abhijeet PHARATE, PUNE (IN); Cédric KETELS, White Lake, MI (US); Didier DURIEZ, LE PLESSIS PATE (FR); Swapnil GATHIBANDHE, Maharashtra (IN); Marine MICHAUD, Paris (FR)

(21) Appl. No.: 18/398,329

(22) Filed: Dec. 28, 2023

(30) Foreign Application Priority Data
Jan. 3, 2023 (FR) 2300040

(51) Int. Cl. B60N 2/66

(52) U.S. Cl. CPC B60N 2/66

(57) ABSTRACT

The present disclosure relates to a modular squab cushion, configured to be attached to a squab structure having a squab structure, the squab structure being configured to removably attach the modular squab cushion, the modular squab cushion comprises, in the assembled state: a main (or central) base having a lower surface configured to be attached to the squab structure, a central padding resting on an upper surface of the main base and forming a central portion, a central trim covering that covers the central padding, at least one modular lateral bolster removably attached to the main base.

### PRIORITY CLAIM

This application claims priority to French Patent Application No. FR2300040, filed Jan. 3, 2023, which is expressly incorporated by reference herein.

### BACKGROUND

The present disclosure relates to the field of vehicle seats.

### SUMMARY

According to the present disclosure, a modular squab cushion is configured to be attached to a squab structure, the squab structure being configured to removably attach the modular squab cushion, the modular squab cushion comprises in the assembled state:
a main base having a lower surface configured to be attached to the squab structure,
a central padding resting on an upper surface of the main base and forming a central portion,
a central trim covering that covers the central padding,
at least one modular lateral bolster removably attached to the main base and comprising in the assembled state:
a lateral base,
a lateral padding resting on an upper surface of the lateral base and forming a raised edge,
a lateral trim covering that covers the lateral padding, the modular cushion comprising a mechanical interface system between the main base and the lateral base, the modular cushion being configured to allow disassembly of the modular lateral bolster of the main base independently of the central padding and the central trim covering, which remain attached to the main base.

In illustrative embodiments, such a configuration of a modular squab cushion comprising at least one modular lateral bolster allows quick mounting on a squab structure, in that the modular squab cushion, a single-piece component, in the assembled state can be quickly fixed to the metal structure of the seat, in particular by forming all the segments of the squab, namely not only the central portion typically forming the medallion of the squab, but also the two lateral parts. The two lateral parts, typically higher along a vertical component relative to the central portion, have the function of laterally holding the occupant onto the squab. Such a configuration also facilitates the maintenance of the squab, and without it being necessary to disassemble the structure of the vehicle floor seat.

In illustrative embodiments, such a configuration allows easy mounting and/or maintenance of the lateral bolster, a modular component independently of the central padding and the central trim covering which remain fixed to the main base, itself attached to the structure of the seat.

In illustrative embodiments, the lateral segment of the squab is often the segment of the squab that wears out most quickly, and typically more quickly than the central segment of the squab. The present disclosure thus allows this quickly-wearing segment to be changed, only without it being necessary to change the central portion of the squab, and in particular the central padding and the central trim covering which remain attached to the main base, itself attached to a seat structure.

In one or more embodiments, the mechanical interface system comprises:
a rear mechanical interface comprising a first coupling part on the main base and a second coupling part on the lateral base, the first coupling part and the second coupling part engaging by interlocking,
a front mechanical interface comprising a first locking part on the main base and a second locking part on the lateral base,

and wherein the rear mechanical interface and the front mechanical interface are configured to allow the fastening of the modular lateral bolster onto the main base as follows:
A. interlocking the first and second coupling parts,
B. pivoting the modular bolster around the rear mechanical interface until the first locking part is joined to the second locking part.

In one or more embodiments, the first locking part and the second locking part interlock elastically during the pivoting in B.

In one or more embodiments, the first locking part comprises a strike and the second locking part comprises a latch, the strike and the latch being opposite at the end of pivoting into B., and wherein a locking of the modular lateral bolster on the main base is obtained as follows:
C. interlocking the latch in the strike.

In one or more embodiments, the first locking part and the second locking part are attached to each other by a screw-nut system.

In one or more embodiments, the mechanical interface system comprises a plurality of first coupling parts arranged on the lateral base and a plurality of second coupling parts arranged on the main base, the first coupling parts and the second coupling parts cooperating by interlocking, and wherein the mechanical interface system is configured to allow the fastening of the modular lateral bolster on the modular squab cushion as follows:
E. facing the first coupling parts with respectively the second coupling parts,
F. vertically translating the modular lateral bolster until the first coupling parts are interlocked with the second coupling parts.

In one or more embodiments, the lateral base comprises a peripheral edge comprising a groove and the lateral trim covering is provided with a system for fastening along at least one end part of the lateral trim covering, the fastening system being configured to penetrate the groove while fastening it.

The present disclosure also relates to a seat assembly comprising a modular squab cushion according to the present disclosure and a seat structure having a squab structure, or even a backrest structure, and wherein, the modular squab cushion comprises in the assembled state:
the main base having a lower surface configured to be attached to the squab structure,
the central padding resting on an upper surface of the main base and forming a central portion,
the central trim covering that covers the central padding,
the at least one modular lateral bolster removably attached to the main base and comprising in the assembled state:
the lateral base,
the lateral padding resting on an upper surface of the lateral base and forming a raised edge,
the lateral trim covering that covers the lateral padding, the modular cushion comprising a mechanical interface system between the main base and the lateral base, the modular cushion being configured to allow the removal of the modular lateral bolster from the main base independently of the central padding and the central trim covering that remain attached to the main base.

The present disclosure also relates to a method for obtaining a seat cushion according to the present disclosure, comprising:
providing a seat structure, in the assembled state, comprising a squab structure, or even a backrest structure,
providing a modular squab cushion according to the present disclosure comprising in the assembled state at least the main base having a lower surface configured to be attached to the squab structure, the central padding resting on an upper surface of the main base and forming a central portion, the central trim covering covering the central padding, and the at least one modular lateral bolster removably attached to the main base, the at least one modular bolster comprising in the assembled state the lateral base, a lateral padding resting on an upper surface of the lateral base and forming a raised edge, a lateral trim covering covering the lateral padding, the modular cushion comprising the mechanical interface system between the main base and the lateral base,
assembling the modular cushion to the squab structure.

In one or more embodiments, the assembly of the modular squab cushion to the seat structure is implemented on a final assembly site, and wherein the modular squab bolster is manufactured on a site distinct from the final assembly site.

The present disclosure also relates to a method for maintaining a seat assembly according to the present disclosure, or obtained according to the present disclosure, comprising disassembling the at least modular lateral bolster from the main base without disassembling the modular squab cushion from the seat structure by the following implementation:
C. unlocking the lateral base from the main base by the fastening system, and successively,
D. removing the at least the modular lateral bolster.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1a shows a seat structure comprising a squab structure and a backrest structure.

FIG. 1b shows a squab structure comprising a modular squab cushion and at least one modular lateral bolster.

FIG. 1c shows the lateral base of the modular lateral bolster.

FIG. 1d schematically shows a schematic sectional view YZ of a modular squab cushion comprising a modular squab bolster.

FIG. 2a shows a first example of a mechanical interface system.

FIG. 2b schematically shows the methodology for placing a modular lateral bolster on a modular squab cushion comprising a mechanical interface system according to FIG. 2a.

FIG. 3a shows a first embodiment of the first and second locking part.

FIG. 3b shows a second embodiment of the first and second locking part.

FIG. 3c shows the second embodiment of the first and second locking part.

FIG. 3d shows a third embodiment of the first and second locking part.

FIG. 3e shows a fourth embodiment of the first and second locking part.

FIG. 4a shows a second example of a mechanical interface system.

FIG. 4b schematically shows the methodology for placing a modular lateral bolster on a modular squab cushion comprising a mechanical interface system according to FIG. 4a.

### DETAILED DESCRIPTION

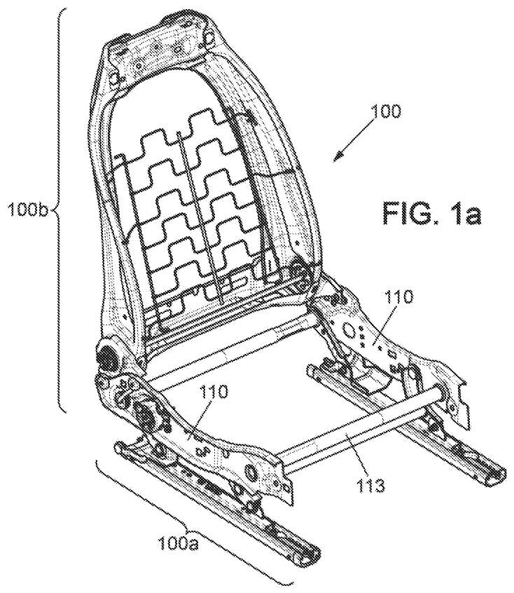

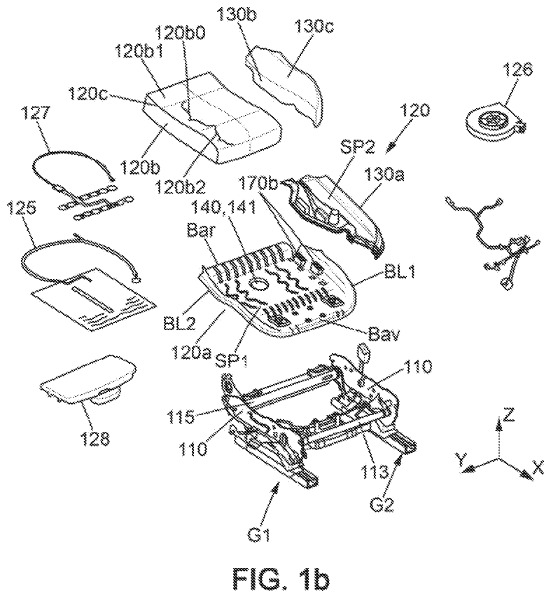

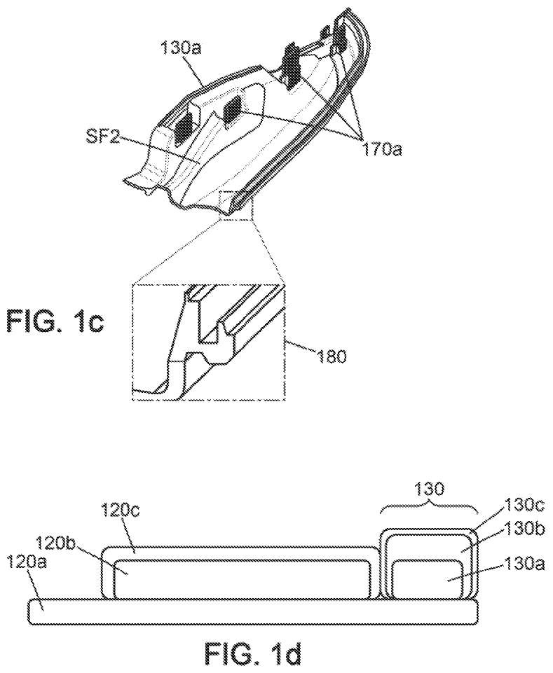

FIGS. 1a to 1d show a seat assembly comprising a modular squab cushion and at least one modular lateral bolster.

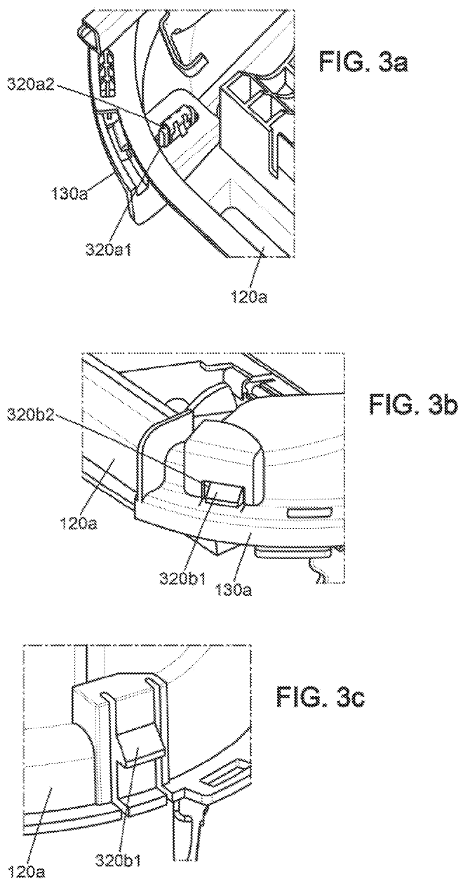

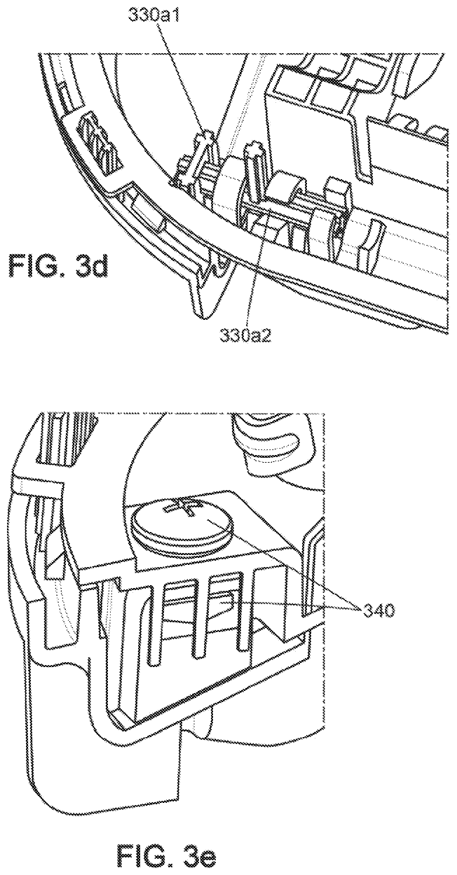

In particular, FIG. 1a shows a seat structure comprising a squab structure and a backrest structure, FIG. 1b shows a squab structure comprising a modular squab cushion and at least one modular lateral bolster, FIG. 3c shows the lateral base of the modular lateral bolster, and FIG. 1d shows a schematic sectional view of a modular squab cushion comprising a modular squab bolster.

Referring to FIGS. 1a, 1b and 1d, the present disclosure may relate to a seat assembly comprising a modular squab cushion 120, configured to be attached to a seat structure 100 having a squab structure 100a and optionally a backrest structure 100b. The squab structure may comprise two lateral flanges 110 spaced apart by a transverse font tube 113 and a transverse rear tube 115, and which is configured to removably attach the modular squab cushion 120.

Furthermore, the modular squab cushion 120 may comprise in the assembled state at least the following components:
a main (or central) base 120a having a lower surface configured to be attached to the squab structure 100a,
a central padding 120b resting on an upper surface SP1 of the main base and forming a central portion,
a central trim covering 120c that covers the central padding, typically being attached to the main base 120a,
at least one modular lateral bolster 130 removably attached to the main base 120a.

The main base 120a can be made of plastic, for example thermoplastic, and may be a body, preferably thin, which extends from a rear edge Bar to a front edge Bav typically along the direction X (longitudinal direction), and a first lateral edge BL1 to a second lateral edge BL2 in the direction Y (transverse direction). The main base may typically be a integrally molded body, typically by injection molding techniques.

The profile of the body, seen in a section passing through a plane XZ, may be an upright profile, under normal conditions of use of the seat of the vehicle, when moving from the rear edge Bar, and toward the front edge Bav, in particular to the front edge of the body. Such an upright profile provides for the hips of the user are held in the seat, while limiting the risks of the submarine effect in the event of a frontal impact.

The profile of the body, seen in a section passing through a plane YZ, can be concave, the first lateral edge BL1, and the second lateral edge BL2 being raised along the direction Z, relative to the body between the two lateral edges BL1, BL2.

Furthermore, the main base 120a may comprise a suspension system 140 typically provided on the main base 120a between the first lateral edge BL1 and the second lateral edge BL2 of the body.

In one or more embodiments, the suspension system 140 can be obtained during injection molding, and may consist of an openwork elastic portion 141 of the base, typically extending, on the base, between the first lateral edge BL1 and the second lateral edge BL2 near the rear edge Bar by comparison with the front edge Bav, namely that the suspension system is situated, in particular along the direction X, closer to the rear edge Bar than from the front edge Bav.

In one or more embodiments, the main base 120a may comprise a suspension system 140 that typically extends over the main base between a first lateral edge and a second lateral edge of the body.

Furthermore, the central padding 120b may further comprise a central portion 120b0, a fixed rear portion 120b1, and a mobile front portion 120b2. The rear portion 120b1 is attached to the base 120a while a slide system 128 can be provided between the main base 120a and the front portion 120b2. This slide system makes it possible to move the front portion 120b2 of the central portion 120b0 forward or backward relative to the rear portion 120b1.

The modular cushion may also comprise, in the assembled state, all or part of the following components:
a resistive electrical heating pad 125, and/or
an electric ventilation system 126, configured to blow air through vents in the base, and/or
a massage system 127, comprising one or more mechanical actuators.

The modular lateral bolster 130 can be arranged on one of the sides of the central padding, along the transverse direction Y, and the function of providing lateral retention of the occupant, the modular lateral bolster can comprise in the assembled state:
a lateral base 130a,
a lateral padding 130b resting on an upper surface SP2 of the lateral base and forming a raised edge,
a lateral covering 130c that covers the lateral padding and typically attached to the lateral base, on all or part of the periphery of the lateral base.

As shown in FIG. 1d, the padding or the coverings are configured to be independent for each base (main or lateral), the padding conferring the softness and comfort of the squab, and can be in a material such as the expanded polyurethane foam. This independence facilitates and improves the maintenance of the squab by avoiding disassembling any unworn parts during replacement. For example, when replacing a modular lateral bolster, it is not necessary to remove the covering and/or the central padding.

In one or more embodiments, the lateral base can be configured so that the lower surface SF2 of the lateral base is in physical contact, in the assembled state, with the upper surface SP1 of the main base. Furthermore, the shape of the lower surface SF2 of the lateral base may be configured to be adapted or complementary to the shape of the upper surface SP1 of the main base.

The lateral base 130a can be made of plastic, for example thermoplastic, and may be a body, preferably thin, which extends from the rear edge Bar to the front edge Bav, and from a first lateral edge of the main base to a second lateral edge of the main base. The lateral base may typically be a integrally molded body, typically by injection molding techniques.

Referring to FIG. 1b and FIG. 1c, the lower surface SF2 of the lateral base may further comprise a plurality of alignment members 170a configured to interlock, in the assembled state, with a plurality of alignment recesses 170b arranged on the upper surface SP1 of the main base, thus participating in holding the lateral base onto the main base in a transverse plane.

Furthermore, in one or more embodiments, the lateral base may comprise a peripheral edge having a groove 180 and the lateral covering may comprise a fastening system, such as a fastening profiled element, arranged along the end of the lateral trim covering, the fastening system, in particular the fastening profiled element configured to penetrate the groove 180 by fastening it to provide for the holding of the lateral covering at the lateral base, the lateral covering covering the lateral padding while providing that it is held on the lateral base.

In one or more preferred embodiments, the modular squab cushion may comprise two modular lateral bolsters arranged on each side of the central portion (and/or the central padding), both attached removably, independently on the main base 120a (or central base). According to such an embodiment, the two cross-sections are modular components in the sense that they are removable by being taken out during maintenance, advantageously without dismantling the main base from the structure of the seat, and while at least the central padding and the central covering remain attached to the main base.

According to a second possible embodiment, the modular squab cushion may comprise a single modular squab bolster, removably and independently attached to the main base, on a first side of the central padding, the other squab bolster, on a second side of the central padding (opposite the first side), comprising a lateral padding resting directly on the main base attached by the central base by the central covering which extends not only on the central portion of the padding, but also on the lateral padding, on this second side.

In such an embodiment, the central padding and the lateral padding of the lateral bolster (non-modular) on the second side may comprise
a single-piece padding which successively forms, in the transverse direction Y, the lateral bolster (non-modular) and the central portion of the padding, or alternatively,
two independent paddings which respectively form, in the transverse direction Y, the lateral bolster (non-modular) and the central portion of the padding.

According to this second possible embodiment, only the modular squab bolster on the first side can be removed during maintenance without dismantling the main base from the squab structure. The modular squab bolster on this first side is typically arranged in a vehicle, on the side near a door of the vehicle, in that it typically involves the bolster being used as quickly as possible when the user enters and exits the vehicle.

Furthermore, the modular cushion may comprise a mechanical interface system between the main base 120a and the lateral base 130a, and which can be configured to allow the disassembly of the modular lateral bolster from the main base, doing so independently of the central padding and the central trim covering.

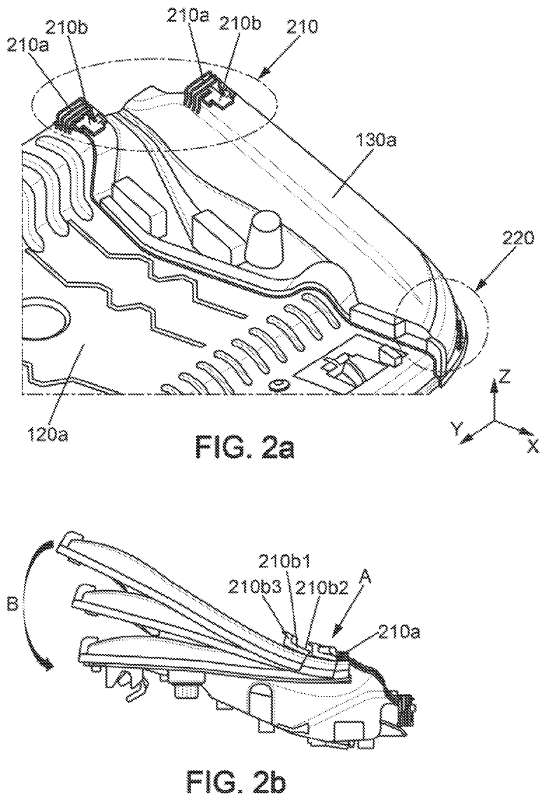

FIG. 2a shows a first example of a mechanical interface system, and FIG. 2b schematically shows the methodology for placing a modular lateral bolster on a modular squab cushion comprising a mechanical interface system according to FIG. 2a.

The main base 120a may comprise a longitudinal direction X, and the mechanical interface system may comprise:
a rear mechanical interface 210 comprising a first coupling part 210a on the main base and a second coupling part 210b on the lateral base, the first coupling part and the second coupling part being cooperating by interlocking,
a front mechanical interface 220 comprising a first locking part on the main base and a second locking part on the lateral base.

The rear mechanical interface and front mechanical interface can be configured to allow fastening of the modular lateral bolster on the following main base:
A. interlocking the first and second coupling parts,
B. pivoting the modular bolster around the rear mechanical interface until the first locking part is joined to the second locking part.

Thus, the placement and fastening of the modular squab cushion to the squab structure as well as at least one modular bolster according to the present disclosure is quick, safe and preferably carried out without a tool, in particular for steps A and B allowing at least one modular lateral bolster.

In one or more embodiments, the main base 120a may be a body obtained by injection molding, and wherein the first coupling portion and the first locking portion are arranged integrally with the body during injection molding. Likewise, the lateral base 130a may be a body obtained by injection molding, and wherein the second coupling portion and the second locking portion are arranged integrally with the body during injection molding.

By way of example, the first coupling part 210a may be arranged on a rear part of the main base and may comprise a plurality of locking members, for example in the form of an inverted U, integral with the rear part of the main base. The second coupling part 210b can be arranged on a rear part of the lateral base, and may comprise a plurality of hooks integral with the rear part of the lateral base and which are configured to lock onto the plurality of locking members. Each hook may comprise a base 210b1 comprising a first free distal end 210b2 and a second distal end topped by a locking tooth 210b3, and the locking tooth being configured to come into contact with a surface of the locking member so as to prevent a rear movement of the modular bolster when the modular bolster is in the assembled state.

During A. corresponding to the interlocking of the first coupling part 210a with the second coupling part 210b, the respective free distal end of each hook can be inserted into the respective locking member until the locking tooth contacts the surface of the locking member, the distal end being inserted at a predetermined angle between 5 and 50 degrees in the XZ plane, and between the free distal end in the assembled state and the free distal end in contact with the surface of the locking member before pivoting.

In one or more embodiments, the first locking part and the second locking part can interlock elastically during the pivoting in B. The first locking part and/or the second locking part can elastically deform until it returns to position, in order to ensure locking.

FIGS. 3a to 3e show various embodiments of the first and second locking parts.

According to a first embodiment shown in FIG. 3a, the first locking part may comprise a through-opening 320al arranged on the upper surface of the front part of the main base (or on a front edge of the main base), and the second locking part may comprise at least one locking clip 320a2 integral with the lower surface of the front part of the lateral base and which is configured to interlock in the through-opening so as to attach (e.g. elastically) the front part of the lateral base to the front part of the main base. The locking clip 320a2 elastically deforms to pass through the through-opening 320al, before deploying, after passage of the through opening 320al, by preventing its removal according to an opposite movement.

According to a second embodiment shown in FIGS. 3b and 3c, the second locking part may comprise a through opening 320b2 arranged on one edge of the front part of the lateral base, and the first locking part may comprise at least one holding clip 320b1 integral with an edge of the front part of the main base and which is configured to interlock in the through-opening so as to fasten (e.g. elastically) the front part of the lateral base onto the front part of the main base.

In one or more embodiments, the clip may be integrally formed (see FIG. 3e) with the main base during injection molding.

According to a third embodiment shown in FIG. 3d, the first locking part may comprise a strike 330al and the second locking part may comprise a latch 330a2. The latch and the strike can be placed opposite at the end of pivoting in B., and the locking of the modular lateral bolster on the main base can be obtained by the following step:
C. interlocking the latch in the strike.

According to a fourth embodiment shown in FIG. 3e, the first locking part and the second locking part can be attached to each other by a screw-nut system 340 for example.

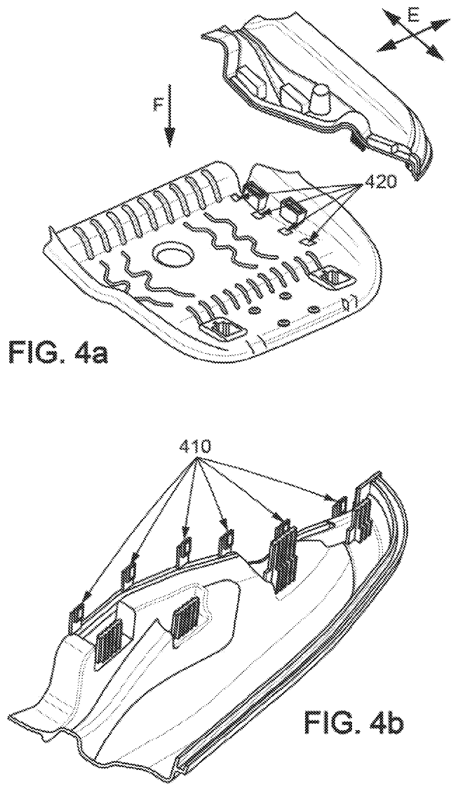

FIG. 4a shows a second example of a mechanical interface system, and FIG. 4b schematically shows the methodology for placing a modular lateral bolster on a modular squab cushion comprising a mechanical interface system according to FIG. 4a.

Referring to FIGS. 4a and 4b, the main base may comprise a longitudinal direction X, and the mechanical interface system may comprise a plurality of first coupling parts 410 arranged on the lateral base and a plurality of second coupling parts 420 arranged on the main base.

For example, the first coupling portions 410 may be arranged on the bottom surface of the lateral base, and more particularly along the inner edge of the bottom surface of the lateral base.

The first coupling parts and the second coupling parts can be configured to interlock (e.g. elastically), the mechanical interface system may be configured to allow the attachment of the modular lateral bolster to the following modular squab cushion:
E. facing the first coupling parts with respectively the second coupling parts,
F. vertically translating the modular lateral bolster until the first coupling parts are interlocked with the second coupling parts.

As an example, the plurality of first coupling parts may comprise a plurality of clips 410 integral with the inner edge of the inner surface of the lateral base, the plurality of integral clips extending perpendicularly from the inner edge. The plurality of second coupling parts may comprise a plurality of locking housings 420 arranged on the upper surface of the main base.

Each clip can be configured to interlock (e.g. elastically), in the assembled state of the modular lateral bolster, with a respective locking recess arranged on the upper surface of the main base.

The present disclosure further relates to a method for obtaining a seat assembly according to the present disclosure comprising the following steps:
providing a seat structure 100, in the assembled state, comprising a squab structure and a backrest structure,
providing a modular squab cushion according to the present disclosure comprising, in the assembled state, at least one main base having a lower surface configured to be attached to the squab structure, a central padding resting on an upper surface of the main base and forming a central portion, a central trim covering that covers the central padding, and furthermore with at least one modular lateral bolster removably attached to the main base, the at least one modular bolster comprising in the assembled state a lateral base, a lateral padding resting on an upper surface of the lateral base and forming a raised edge, a lateral covering that covers the lateral padding, the modular cushion comprising a removable attachment system between the main base and the lateral base,
assembling the modular cushion to the squab structure.

The assembly of the modular squab cushion to the seat structure can be implemented on a final assembly site, while manufacturing of the modular squab cushion itself, and in particular the assembly of its various components, implemented on a site distinct from the final assembly site.

The manufacture of the modular squab cushion may comprise, initially, the pre-assembly of the modular lateral bolster by assembling the lateral base, the lateral padding and the lateral covering, and on the other hand, the pre-assembling of the central padding on the main base and the main covering that covers the central padding by fastening it to the main base. It is then possible to fasten the modular lateral bolster (or the two modular lateral bolsters) to the main base. The assembly between the modular cushion and the seat structure as well as between the modular bolster and the modular cushion, can also allow rapid disassembly, and advantageously a disassembly/removal of the modular cushion and/or the modular lateral bolster without disassembling the seat structure from the floor of the vehicle.

Also, the present disclosure also relates to a method for maintaining a seat assembly according to the present disclosure, comprising disassembling at least the modular lateral bolster from the main base without disassembling the modular squab cushion from the seat structure by the following implementation:
C. unlocking the lateral base from the main base by the mechanical interface system, and successively
D. removing the at least the modular lateral bolster.

Such a removal of at least one modular lateral bolster, without dismantling the squab structure, allows easy maintenance of the bolster, by replacing one or more worn elements, for example replacing one or more fillers/covering/padding, by substituting a new modular bolster, or even one improved with comfort equipment.

Comparative vehicle seats use a seat design in which the various components of the seat to be assembled at a site, typically according to just-in-time manufacturing also referred to by the abbreviation “JIT”.

The structure of the comparative seat of a motor vehicle comprises a metal seat structure which may comprise a squab structure and a backrest structure.

The comparative seat structure may comprise:
two slides, right and left G1, G2, each comprising a lower profile, typically female, fixed relative to a floor, and an upper, male profile mounted slidably relative to the lower profile, typically along a direction X which can be the direction of advance of the vehicle,
a squab structure that may comprise two flanges, right and left, spaced apart by tubes, and in particular a front tube spacing the flanges, on a front portion of the squab structure and a rear tube spacing the flanges on a rear portion of the squab structure, the front and rear tubes extending parallel, in a transverse direction,
a metal nose piece that connects front ends of the flanges and is shaped to form a support surface for the support of the squab cushion.

The height of the squab structure, namely the assembly that comprises the flanges and the nose piece, can typically be adjusted by a raising system which may comprise a pair of front, right and left, connecting rods connecting the front tube and the upper profiles of the right and left slides, and a rear, right and left connecting rod gap connecting the rear tube and the upper profiles of the slides, right and left.

The squab of such a seat may further comprise a squab padding, typically expanded polyurethane foam, and a trim covering that covers the foam squab padding. The seat may further comprise at least one lateral bolster formed of a lateral padding, typically expanded polyurethane foam, for example arranged on either side of the squab cushion or forming a single block with the squab cushion, the assembly being covered by the trim covering.

The squab of a seat tends to wear over time, which can result in wear of the trim covering/padding, or even a tear in the trim covering and/or the padding.

When replacing a part of the damaged squab, it is generally necessary to best remove the complete base or even this operation being often carried out after removing the entire seat from the vehicle.

Another modular design of the squab that comprises a support base, often plastic, padding and a cover element, which can be preassembled, very often on a site distinct from the final assembly site, typically with more competitive labor costs.

The final assembly is obtained by fastening the modular squab cushion, which is formed from a single piece, on the squab of the seat, quickly during the final assembly. During maintenance, for example when a component of the squab is worn, it is possible to remove the squab module in full, and to replace it with a new squab module. Such a solution is particularly satisfactory during the implementation of the final assembly due to an improved manufacturing time during final assembly, it requires, during maintenance, changing the entire squab module, and even if only part of the module is damaged.

One comparative solution to this problem is by a divided design of the squab module, and of the backrest module, each module (squab or backrest), being composed of three parts, consisting of a main part, and two lateral parts arranged on either side of the central part. The benefit of such a comparative divided design is to be able, during maintenance, only to change a segment only of the squab (or backrest), at low cost. This maintenance solution is in fact less expensive compared to comparative designs requiring replacement of the entire squab module. This comparative solution is however not completely satisfactory, and in particular during final assembly, in that it uses the assembly of numerous module segments on the squab structure, in particular for the squab, which increases the seat-manufacturing cycle time at the final assembly site. The present disclosure improves the situation.

A modular squab cushion is thus proposed configured to be attached to a squab structure, the squab structure being configured to removably attach the modular squab cushion, the modular squab cushion comprises in the assembled state:
a main base having a lower surface configured to be attached to the squab structure,
a central padding resting on an upper surface of the main base and forming a central portion,
a central trim covering that covers the central padding,
at least one modular lateral bolster removably attached to the main base and comprising in the assembled state:
a lateral base,
a lateral padding resting on an upper surface of the lateral base and forming a raised edge,
a lateral trim covering that covers the lateral padding, the modular cushion comprising a mechanical interface system between the main base and the lateral base, the modular cushion being configured to allow disassembly of the modular lateral bolster of the main base independently of the central padding and the central trim covering, which remain attached to the main base.

Thus, advantageously, such a configuration of a modular squab cushion comprising at least one modular lateral bolster allows quick mounting on a squab structure, in that the modular squab cushion, a single-piece component, in the assembled state can be quickly fixed to the metal structure of the seat, in particular by forming all the segments of the squab, namely not only the central portion typically forming the medallion of the squab, but also the two lateral parts. The two lateral parts, typically higher along a vertical component relative to the central portion, have the function of laterally holding the occupant onto the squab. Such a configuration also facilitates the maintenance of the squab, and without it being necessary to disassemble the structure of the vehicle floor seat.

Furthermore, and in a notable manner, advantageously, such a configuration allows easy mounting and/or maintenance of the lateral bolster, a modular component independently of the central padding and the central trim covering which remain fixed to the main base, itself attached to the structure of the seat.

The present disclosure is in particular born from the inventors' observation that the lateral segment of the squab is often the segment of the squab that wears out most quickly, and typically more quickly than the central segment of the squab. The present disclosure thus allows this quickly-wearing segment to be changed, only without it being necessary to change the central portion of the squab, and in particular the central padding and the central trim covering which remain attached to the main base, itself attached to a seat structure.

In one or more embodiments, the mechanical interface system comprises:
a rear mechanical interface comprising a first coupling part on the main base and a second coupling part on the lateral base, the first coupling part and the second coupling part engaging by interlocking,
a front mechanical interface comprising a first locking part on the main base and a second locking part on the lateral base,

and wherein the rear mechanical interface and the front mechanical interface are configured to allow the fastening of the modular lateral bolster onto the main base as follows:
A. interlocking the first and second coupling parts,
B. pivoting the modular bolster around the rear mechanical interface until the first locking part is joined to the second locking part.

In one or more embodiments, the first locking part and the second locking part interlock elastically during the pivoting in B.

In one or more embodiments, the first locking part comprises a strike and the second locking part comprises a latch, the strike and the latch being opposite at the end of pivoting into B., and wherein a locking of the modular lateral bolster on the main base is obtained as follows:
C. interlocking the latch in the strike.

In one or more embodiments, the first locking part and the second locking part are attached to each other by a screw-nut system.

In one or more embodiments, the mechanical interface system comprises a plurality of first coupling parts arranged on the lateral base and a plurality of second coupling parts arranged on the main base, the first coupling parts and the second coupling parts cooperating by interlocking, and wherein the mechanical interface system is configured to allow the fastening of the modular lateral bolster on the modular squab cushion as follows:
E. facing the first coupling parts with respectively the second coupling parts,
F. vertically translating the modular lateral bolster until the first coupling parts are interlocked with the second coupling parts.

In one or more embodiments, the lateral base comprises a peripheral edge comprising a groove and the lateral trim covering is provided with a system for fastening along at least one end part of the lateral trim covering, the fastening system being configured to penetrate the groove while fastening it.

The present disclosure also relates to a seat assembly comprising a modular squab cushion according to the present disclosure and a seat structure having a squab structure, or even a backrest structure, and wherein, the modular squab cushion comprises in the assembled state:
the main base having a lower surface configured to be attached to the squab structure,
the central padding resting on an upper surface of the main base and forming a central portion,
the central trim covering that covers the central padding,
the at least one modular lateral bolster removably attached to the main base and comprising in the assembled state:
the lateral base,
the lateral padding resting on an upper surface of the lateral base and forming a raised edge,
the lateral trim covering that covers the lateral padding,
the modular cushion comprising a mechanical interface system between the main base and the lateral base,
the modular cushion being configured to allow the removal of the modular lateral bolster from the main base independently of the central padding and the central trim covering that remain attached to the main base.

The present disclosure also relates to a method for obtaining a seat cushion according to the present disclosure, comprising:
providing a seat structure, in the assembled state, comprising a squab structure, or even a backrest structure,
providing a modular squab cushion according to the present disclosure comprising in the assembled state at least the main base having a lower surface configured to be attached to the squab structure, the central padding resting on an upper surface of the main base and forming a central portion, the central trim covering covering the central padding,

and the at least one modular lateral bolster removably attached to the main base, the at least one modular bolster comprising in the assembled state the lateral base, a lateral padding resting on an upper surface of the lateral base and forming a raised edge, a lateral trim covering covering the lateral padding, the modular cushion comprising the mechanical interface system between the main base and the lateral base,
assembling the modular cushion to the squab structure.

In one or more embodiments, the assembly of the modular squab cushion to the seat structure is implemented on a final assembly site, and wherein the modular squab bolster is manufactured on a site distinct from the final assembly site.

The present disclosure also relates to a method for maintaining a seat assembly according to the present disclosure, or obtained according to the present disclosure, comprising disassembling the at least modular lateral bolster from the main base without disassembling the modular squab cushion from the seat structure by the following implementation:
C. unlocking the lateral base from the main base by the fastening system, and successively,
D. removing the at least the modular lateral bolster.

The following numbered clauses include embodiments that are contemplated and non-limiting:

Clause 1. A modular squab cushion (120) configured to be attached to a squab structure (100a), the squab structure being configured to removably attach the modular squab cushion,
the modular squab cushion (120) comprises, in the assembled state:
   a main base (120a) having a lower surface configured to be attached to the squab structure (100a),
   a central padding (120b) resting on an upper surface of the main base and forming a central portion,
   a central trim covering (120c) that covers the central padding,
   at least one modular lateral bolster (130) removably attached to the main base and comprising in the assembled state:
   a lateral base (130a),
   a lateral padding (130b) resting on an upper surface of the lateral base and forming a raised edge,
   a covering lateral covering (130c) covering the lateral padding,
the modular cushion comprising a mechanical interface system between the main base (120a) and the lateral base (130a),
the modular cushion being configured to allow disassembly of the modular lateral bolster of the main base independently of the central padding and the central trim covering, which remain attached to the main base.

Clause 2. The modular squab cushion according to the preceding clause, wherein the mechanical interface system comprises:
a rear mechanical interface (210) comprising a first coupling part (210a) on the main base and a second coupling part (210b) on the lateral base, the first coupling part and the second coupling part cooperating by interlocking,
a front mechanical interface (220) comprising a first locking part (320a1; 320b1; 330a2) on the main base and a second locking part (320a2; 320b2; 330a1) on the lateral base,
and wherein the rear mechanical interface and the front mechanical interface are configured to allow the fastening of the modular lateral bolster onto the main base as follows:
A. interlocking the first and second coupling parts,
B. pivoting the modular bolster around the rear mechanical interface until the first locking part is joined to the second locking part.

Clause 3. The modular squab cushion according to the preceding clause, wherein the first locking part (320a1; 320b1) and the second locking part (320a2; 320b2) elastically interlock during pivoting into B.

Clause 4. The modular squab cushion according to one of clauses 1 to 2, wherein the first locking part comprises a strike (330a1) and the second locking part comprises a latch (330a2), the strike and the latch being placed opposite at the end of pivoting into B., and wherein a locking of the modular lateral bolster on the main base is obtained as follows:
C. interlocking the latch in the strike.

Clause 5. The modular squab cushion according to one of clauses 1 to 2, wherein the first locking part and the second locking part are attached to each other by a screw-nut system (340).

Clause 6. The modular squab cushion according to clause 1, wherein the mechanical interface system comprises a plurality of first coupling parts (410) arranged on the lateral base and a plurality of second coupling parts (420) arranged on the main base, the first coupling parts and the second coupling parts cooperating by interlocking,
and wherein the mechanical interface system is configured to allow the fastening of the modular lateral bolster on the modular squab cushion as follows:
E. facing the first coupling parts with respectively the second coupling parts,
F. vertically translating the modular lateral bolster until the first coupling parts are interlocked with the second coupling parts.

Clause 7. The modular squab cushion according to one of the preceding clauses, wherein the lateral base comprises a peripheral edge comprising a groove and the lateral trim covering is provided with a system for fastening along at least one end part of the lateral trim covering, the fastening system being configured to penetrate the groove while fastening it.

Clause 8. A seat assembly comprising a modular squab cushion (130) according to one of clauses 1 to 7 and a seat structure (100) having a squab structure (100a), or a backrest structure (100b) and wherein,
the modular squab cushion comprises in the assembled state:
   the main base having a lower surface configured to be attached to the squab structure,
   the central padding resting on an upper surface of the main base and forming a central portion,
   the central trim covering that covers the central padding,
   the at least one modular lateral bolster removably attached to the main base and comprising in the assembled state:
   the lateral base,
   the lateral padding resting on an upper surface of the lateral base and forming a raised edge,
   the lateral trim covering that covers the lateral padding,
the modular cushion comprising a mechanical interface system between the main base and the lateral base,
the modular cushion being configured to allow the removal of the modular lateral bolster from the main base independently of the central padding and the central trim covering that remain attached to the main base.

Clause 9. A method for obtaining a seat assembly according to clause 8 comprising:
providing a seat structure (100), in the assembled state, comprising a squab structure (110a) and a backrest structure (110b),
providing a modular squab cushion according to one of claims 1 to 7 comprising in the assembled state at least the main base having a lower surface configured to be attached to the squab structure, the central padding resting on an upper surface of the main base and forming a central portion, the central trim covering the central padding,
and the at least one modular lateral bolster removably attached to the main base, the at least one modular bolster comprising in the assembled state the lateral base, a lateral padding resting on an upper surface of the lateral base and forming a raised edge, a lateral trim covering covering the lateral padding, the modular cushion comprising the mechanical interface system between the main base and the lateral base,
assembling the modular cushion to the squab structure.

Clause 10. A method for maintaining a seat assembly according to clause 8, or obtained according to clause 9, comprising disassembling the at least modular lateral bolster from the main base without disassembling the modular squab cushion from the squab structure by the following implementation:
C. unlocking the lateral base from the main base by the fastening system, and successively,
D. removing the at least the modular lateral bolster.

1. A modular squab cushion configured to be attached to a squab structure, the squab structure being configured to removably attach the modular squab cushion, the modular squab cushion comprises, in the assembled state:
a main base having a lower surface configured to be attached to the squab structure,
a central padding resting on an upper surface of the main base and forming a central portion,
a central trim covering that covers the central padding,
at least one modular lateral bolster removably attached to the main base and comprising in the assembled state:
a lateral base,
a lateral padding resting on an upper surface of the lateral base and forming a raised edge,
a covering lateral covering covering the lateral padding, the modular cushion comprising a mechanical interface system between the main base and the lateral base,
the modular cushion being configured to allow disassembly of the modular lateral bolster of the main base independently of the central padding and the central trim covering, which remain attached to the main base.

2. The modular squab cushion of claim 1, wherein the mechanical interface system comprises:
a rear mechanical interface comprising a first coupling part on the main base and a second coupling part on the lateral base, the first coupling part and the second coupling part cooperating by interlocking,
a front mechanical interface comprising a first locking part on the main base and a second locking part on the lateral base,
and wherein the rear mechanical interface and the front mechanical interface are configured to allow the fastening of the modular lateral bolster onto the main base as follows:
A. interlocking the first and second coupling parts,
B. pivoting the modular bolster around the rear mechanical interface until the first locking part is joined to the second locking part.

3. The modular squab cushion of claim 1, wherein the first locking part and the second locking part elastically interlock during pivoting into B.

4. The modular squab cushion of claim 1, wherein the first locking part comprises a strike and the second locking part comprises a latch, the strike and the latch being placed opposite at the end of pivoting into B, and wherein a locking of the modular lateral bolster on the main base is obtained as follows:
C. interlocking the latch in the strike.

5. The modular squab cushion of claim 1, wherein the first locking part and the second locking part are attached to each other by a screw-nut system.

6. The modular squab cushion of claim 1, wherein the mechanical interface system comprises a plurality of first coupling parts arranged on the lateral base and a plurality of second coupling parts arranged on the main base, the first coupling parts and the second coupling parts cooperating by interlocking, and wherein the mechanical interface system is configured to allow the fastening of the modular lateral bolster on the modular squab cushion as follows:
E. facing the first coupling parts with respectively the second coupling parts,
F. vertically translating the modular lateral bolster until the first coupling parts are interlocked with the second coupling parts.

7. The modular squab cushion of claim 1, wherein the lateral base comprises a peripheral edge comprising a groove and the lateral trim covering is provided with a system for fastening along at least one end part of the lateral trim covering, the fastening system being configured to penetrate the groove while fastening it.

8. A seat assembly comprising the modular squab cushion of claim 1 and a seat structure having a squab structure, or a backrest structure and wherein,
the modular squab cushion comprises in the assembled state:
the main base having a lower surface configured to be attached to the squab structure,
the central padding resting on an upper surface of the main base and forming a central portion,
the central trim covering that covers the central padding,
the at least one modular lateral bolster removably attached to the main base and comprising in the assembled state:
the lateral base,
the lateral padding resting on an upper surface of the lateral base and forming a raised edge,
the lateral trim covering that covers the lateral padding, the modular cushion comprising a mechanical interface system between the main base and the lateral base,
the modular cushion being configured to allow the removal of the modular lateral bolster from the main base independently of the central padding and the central trim covering that remain attached to the main base.

9. A method for obtaining the seat assembly according to claim 8 comprising:
providing a seat structure, in the assembled state, comprising a squab structure and a backrest structure,
providing the modular squab cushion comprising in the assembled state at least the main base having a lower surface configured to be attached to the squab structure, the central padding resting on an upper surface of the main base and forming a central portion, the central trim covering the central padding,
and the at least one modular lateral bolster removably attached to the main base, the at least one modular bolster comprising in the assembled state the lateral base, a lateral padding resting on an upper surface of the lateral base and forming a raised edge, a lateral trim covering covering the lateral padding, the modular cushion comprising the mechanical interface system between the main base and the lateral base,
assembling the modular cushion to the squab structure.

10. A method for maintaining the seat assembly according to claim 8, comprising disassembling the at least modular lateral bolster from the main base without disassembling the modular squab cushion from the squab structure by the following implementation:
C. unlocking the lateral base from the main base by the fastening system, and successively,
D. removing the at least the modular lateral bolster.
